(19) United States
(12) Patent Application Publication
(10) Pub. No.: US 2019/0084107 A1
(43) Pub. Date: Mar. 21, 2019

(54) ELECTRIC ROTARY TOOL WITH BRAKING

(71) Applicant: MAKITA CORPORATION, ANJI-SHI (JP)

(72) Inventor: Michisada YABUGUCHI, Anjo-shi (JP)

(73) Assignees: MAKITA CORPORATION, ANJO-SHI (JP); MAKITA CORPORATION, ANJO-SHI (JP)

(21) Appl. No.: 16/131,525

(22) Filed: Sep. 14, 2018

(30) Foreign Application Priority Data
Sep. 19, 2017 (JP) 2017-178804

(51) Int. Cl. B23Q 5/10; B25F 5/00

(52) U.S. Cl. CPC B23Q 5/10; B27B 5/38; B25F 5/001

(57) ABSTRACT

A rotary tool or machine includes: an output shaft; a motor that rotates the output shaft; an operation part for commanding driving/stopping of the motor; and a control unit that controls the driving/stopping of the motor in accordance with commands from the operation part. The control unit is configured to generate a braking force in the motor or on the output shaft when the motor is to be stopped in proportion to a tightening force (torque) applied to the tool accessory when the motor is started up, such that the greater the tightening force (torque), the greater the braking force.

### CROSS-REFERENCE

This application claims priority to Japanese patent application serial number 2017-178804, filed on Sep. 19, 2017, the contents of which are incorporated herein by reference in their entirety.

### TECHNICAL FIELD

The present disclosure relates to an electric rotary tool or machine, e.g., an electric work machine, comprising a rotatable output shaft, on which a tool accessory is mounted by screwing a screw or by another threaded connection, such as a nut and bolt.

### BACKGROUND ART

Known rotary tools and machines, such as grinders, circular saws, mowers (lawn mowers), and the like, have a tool accessory, such as a grinding stone, a cutting stone, a rotary cutting blade, or the like, mounted on a tip portion of a rotary output shaft using a threaded connection (threaded fastener), such as a nut and bolt or a screw.

A motor rotates the output shaft around a rotational axis and thereby rotates the tool accessory. Therefore, the rotational direction of the output shaft is set to be the same direction that causes the screw or nut to tighten with respect to the output shaft while the motor is accelerating the output shaft from standstill (zero rotations per minute) to the operating rotational speed. Consequently, in such rotary tools and machines, when the motor starts up and the output shaft is rotated from standstill to its maximum (target) rotational speed for the operation, the screw or nut (slightly) turns relative to the output shaft such that it tightens the tool accessory relative to the output shaft, and thereby the tool accessory remains securely fixed to the output shaft during operation.

In the rotary tool described in Japanese Laid-open Patent Publication 2014-104536, loosening of the tool accessory caused by the fastening screw or lock nut rotating in the loosening direction can be reduced or even avoided when an operation switch is turned off to stop the drive of the motor, even if a braking force is generated by applying a braking current to the motor to stop the rotation of the motor (and thus the tool accessory) more quickly.

### SUMMARY OF THE INVENTION

The tightening force (torque), which is applied to, e.g., the screw or nut that holds the tool accessory on the output shaft when the motor is being started up, increases, e.g., in proportion to a rotational speed increase of the motor; for example, the greater the acceleration, the target rotational speed, the angular impulse (acceleration integrated over time), etc., of the rotary output shaft from when the motor is started up until the rotary output shaft reaches its target rotational speed, the greater the tightening force (torque) applied to the screw, nut, etc. (threaded fastener) that holds the tool accessory on the output shaft during that time.

Therefore, e.g., if the user can variably set the target (maximum) rotational speed during operation (e.g., by performing an external (manual) operation) when the motor is started up, then the tightening force applied to the threaded fastener during the motor startup will change in proportion to the set target rotational speed, assuming that a constant acceleration is always applied to the rotary output shaft.

Consequently, in the above described Japanese Laid-open Patent Publication 2014-104536, when a braking current is applied to generate a braking force to stop the motor more quickly, it is necessary to set the braking force to a small (low) value so that there is no loosening of the nut or screw that holds the tool accessory on the output shaft in case the tightening force (torque) applied to the nut or screw during motor startup was small.

However, if a small (low) braking force is always generated in the motor, then the higher the set (target) rotational speed is when the motor is driven to perform a processing information, the longer the brake time needed to stop the motor and output shaft. Consequently, user-friendliness of the rotary tool or machine is negatively affected in such circumstances (i.e. higher rotating speeds during operation) because the user must wait a longer time for the tool accessory to stop rotating.

One non-limiting object of the present disclosure is to provide a technique for adjusting a braking force generated when the motor of a rotary tool is to be stopped, so that the rotation of an output shaft can be stopped in a shorter time while still minimizing or avoiding a loosening of the tool accessory mounted on the output shaft.

An electric rotary tool or machine (e.g., an electric work machine) according to one non-limiting aspect of the present disclosure comprises: an output shaft configured such that a tool accessory can be mounted thereon using a threaded connection, e.g., a threaded fastener, such as a screw or a nut and bolt; a motor (electric motor) that directly or indirectly (e.g., via a gear transmission, such as a reduction gear, bevel gear, etc.) rotates the output shaft; an operation part (e.g., a switch, more preferably a manual switch) for commanding (manually controlling the) driving/stopping of the motor; and a control unit that controls the driving/stopping of the motor in part based upon commands from the operation part.

Furthermore, the control unit is configured to cause a braking force to be generated in the motor and/or on the output shaft when the motor is to be stopped. The control unit is configured to variably set the braking force in proportion to a tightening force (torque) applied to the tool accessory (more specifically, applied to the screw or nut holding the tool accessory on the output shaft) while the motor is being started up (e.g., from motor standstill until the rotary output shaft reaches its target (maximum or peak) rotational speed for the particular processing operation), such that the greater the tightening force (torque) during the motor startup, the greater the braking force that may be applied when the motor is to be stopped.

Consequently, according to electric rotary tools or machines (e.g., electric work machines) of this aspect of the present disclosure, when the tightening force (torque) applied to the threaded fastener holding the tool accessory on the output shaft during startup of the motor is small (low), the braking force when the motor is being stopped is preferably set to a relatively small (low) value, such that loosening of the threaded fastener (e.g., nut, screw, etc.) of the tool accessory can be minimized or even avoided during motor stoppage (braking). As a result, the risk that the tool accessory unintentionally falls off the output shaft during operation can be reduced or possibly even eliminated.

On the other hand, when the rotational speed increase, acceleration, angular impulse, etc. during startup of the motor is large and thus the tightening force (torque) applied to the tool accessory is large (in other words, when the fastener of the tool accessory is tightened more securely (tightly) owing to the faster motor startup), the time required to stop the motor can be shortened by applying (generating) a relatively large braking force to stop the motor more quickly than if a relatively small or no braking force had been applied (generated).

Therefore, in this aspect of the present disclosure, by appropriately adjusting the braking force generated when (while) the motor is being stopped, rotation of the output shaft can be stopped in a shorter time while also reducing or minimizing the likelihood that the fastener of the tool accessory will loosen during the deceleration (braking) of the output shaft.

In an additional embodiment of this aspect of the present disclosure, the electric rotary tool or machine may further comprise a rotational speed setting part (e.g., a dial, a switch, a slide switch, a toggle switch, an up/down switch, etc.) that enables the user to set (e.g., manually set) the target (maximum or peak) rotational speed when the motor is being driven during operation of the rotary tool or machine. In such an embodiment, the control unit may be configured, e.g., to control (variably set or adjust) the braking force that is applied while the motor is being stopped in proportion to the target (maximum) rotational speed that was set using the rotational speed setting part when the motor is started up.

In this embodiment, the rotational speed setting part may be configured to set the target (maximum) rotational speed when the motor is being driven in proportion to a manipulation amount (manually adjustable movement) of the rotational speed setting part, e.g., an amount of rotation (change in rotational angle), an amount of linear movement, etc., of the rotational speed setting part. In such an embodiment, the control unit may be configured to control (variably adjust) the braking force when the motor is being stopped in proportion to the manipulation amount (positional setting, total movement, etc.) of the rotational speed setting part.

In such embodiments, the control unit may be configured to control (increase/decrease) the braking force, when the motor is being stopped, in proportion to the (variable) tightening force (torque) applied to fastener of the tool accessory while the rotational speed of the motor increases from zero to the target (maximum) rotational speed that was manually set using the rotational speed setting part.

In a further embodiment, the control unit may be configured to determine the actual (current) rotational speed of the motor (or output shaft) when (at the time that) the command to stop the motor is input into the control unit. In such an embodiment, if the rotational speed of the motor had not yet reached the target (maximum) rotational speed, which was manually set using the rotational speed setting part, when the command to stop the motor is input, the braking force may be set to be smaller than a (higher, larger) braking force corresponding to the target (maximum) rotational speed that was set. That is, the control unit may be configured to select or set the braking force in proportion to the detected actual (current) rotational speed of the motor or output shaft at the time the command to stop the motor is input to the control unit, such that, e.g., the braking force is lower for lower detected actual (current) rotational speeds and the braking force is higher for higher detected actual (current) rotational speeds.

In other words, the control unit of such an embodiment may be configured to select or set the braking force for stopping the motor in proportion to the actual (current) rotational speed at the time when the braking of the motor starts.

Therefore, in this aspect of the present disclosure as well, by appropriately adjusting (increasing/decreasing) the braking force generated (applied) while the motor is being stopped in proportion to the detected actual (current) rotational speed (rather than the target (maximum) rotational speed that was set using the rotational speed setting part), rotation of the output shaft can be stopped in a shorter time while still reducing or minimizing the likelihood that the fastener of the tool accessory will loosen during the deceleration (braking) of the motor and output shaft.

In a further embodiment of the present teachings, the control unit may be configured to directly control the braking force generated in the motor (or applied to the rotary output shaft) by controlling (variably adjusting or setting) a braking current that flows to the motor while the motor is being stopped.

In addition, the control unit optionally may be configured to stop the motor when a motor stop command is input from the operation part (e.g., a manual ON/OFF switch) by first cutting off the flow of current to the motor (without applying a braking current) for a prescribed (predetermined) standby time and then, after the elapse of the prescribed (predetermined) standby time, applying a braking current to the motor. In such an embodiment, a lower braking force may be applied by suitably adjusting the standby time.

### BRIEF DESCRIPTION OF THE DRAWINGS

FIG. 1 is an oblique view that shows the overall configuration of a grinder according to a first embodiment of the present teachings.

FIG. 2 is a side view that shows a portion of the grinder where a tool accessory is mounted on a rotary output shaft of the grinder.

FIG. 3 is a block diagram that shows the overall configuration of a representative, non-limiting drive system of the grinder.

FIG. 4 is a flow chart that shows a representative, non-limiting control process executed by a controller.

FIG. 5 is an explanatory diagram that shows a representative, non-limiting map (graph) used by the control process shown in FIG. 4 to set (select) a braking force.

FIG. 6A is a time chart that shows changes in motor rotational speed according to the first embodiment, for the case in which a set rotational speed is large (high); FIG. 6B is a time chart that shows changes in motor rotational speed according to the first embodiment, for the case in which the set rotational speed is small (low).

FIG. 7 is a flow chart that shows a representative, non-limiting control process executed by a controller according to a second embodiment.

FIG. 8 is an explanatory diagram that shows a representative, non-limiting map (graph) used to set (select) a standby time in the control process shown in FIG. 7.

FIG. 9A is a time chart that shows changes in the motor rotational speed according to the second embodiment, for the case in which the set rotational speed is large (high); FIG. 9B is a time chart that shows changes in the motor rotational speed according to the second embodiment, for the case in which the set rotational speed is small (low).

FIG. 10A is a time chart that shows changes in the motor rotational speed according to Modified Example 1, for the case in which the acceleration during startup is high; FIG. 10B is a time chart that shows changes in the motor rotational speed according to Modified Example 1, for the case in which the acceleration during startup is low.

FIG. 11A is a time chart that shows changes in motor rotational speed according to Modified Example 2, for the case in which the set rotational speed during startup is large (high) and then the rotational speed is manually decreased during operation; FIG. 11B is a time chart that shows changes in motor rotational speed according to Modified Example 2, for the case in which the set rotational speed during startup is small (low) and then the rotational speed is manually increased during operation.

### DETAILED DESCRIPTION OF THE EMBODIMENTS

Illustrative embodiments of the present disclosure are explained below, with reference to the drawings. It is noted that, in the embodiments described in detail hereinbelow, a grinder that performs processing, such as grinding, polishing, cutting, or the like, on a workpiece is provided as a representative, non-limiting example of an electric rotary tool or machine (e.g., an electric work machine) of the present disclosure, although the present teachings are generally applicable to any kind of rotary tool or machine. Furthermore, it is noted that the terms “rotary tool” and “rotary machine” are meant to be interchangeable and have the same meaning/scope. Both terms are intended to cover devices that use power (e.g., electric current, combustible fuel, etc.) to generate a rotational force that causes a tool accessory to rotate so that processing work can be performed on a workpiece, vegetation (e.g., grass, hedges, etc.) using the rotating tool accessory and that have a fastener of the tool accessory or the tool accessory itself that could undesirably loosen in the event that too large of a braking force is applied to stop rotation of the motor and/or output shaft that is rotating the tool accessory. Therefore, no inference or distinction should be drawn from the use of only one of “rotary tool” or “rotary machine” in the specification or claims unless explicitly stated.

### First Embodiment

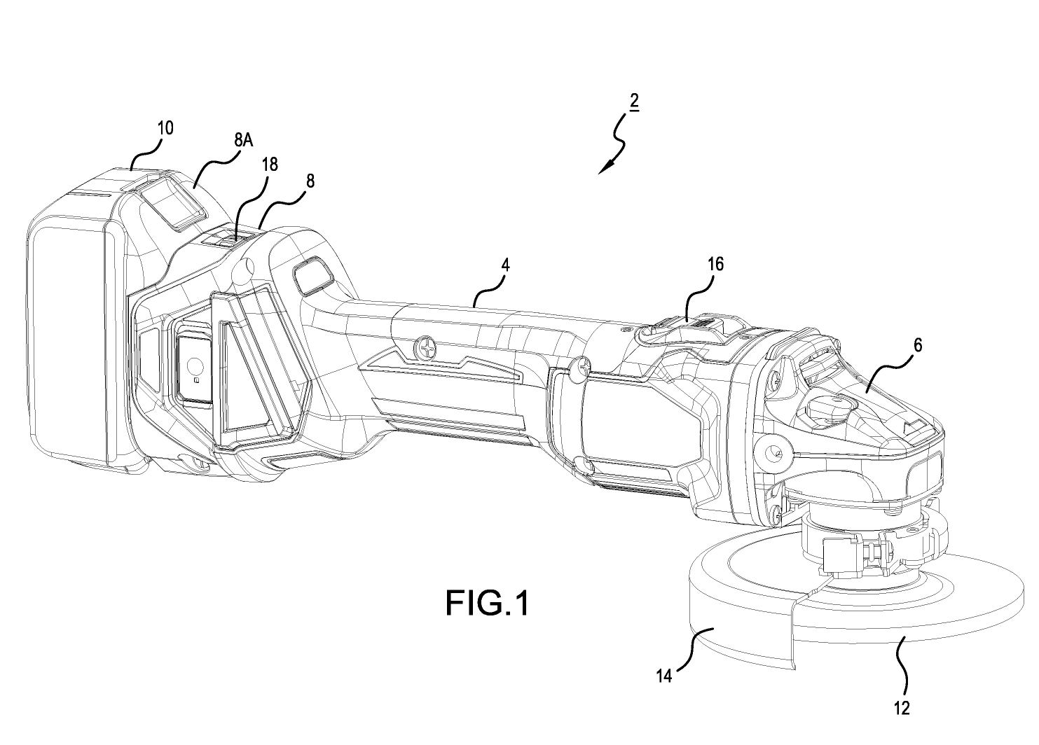

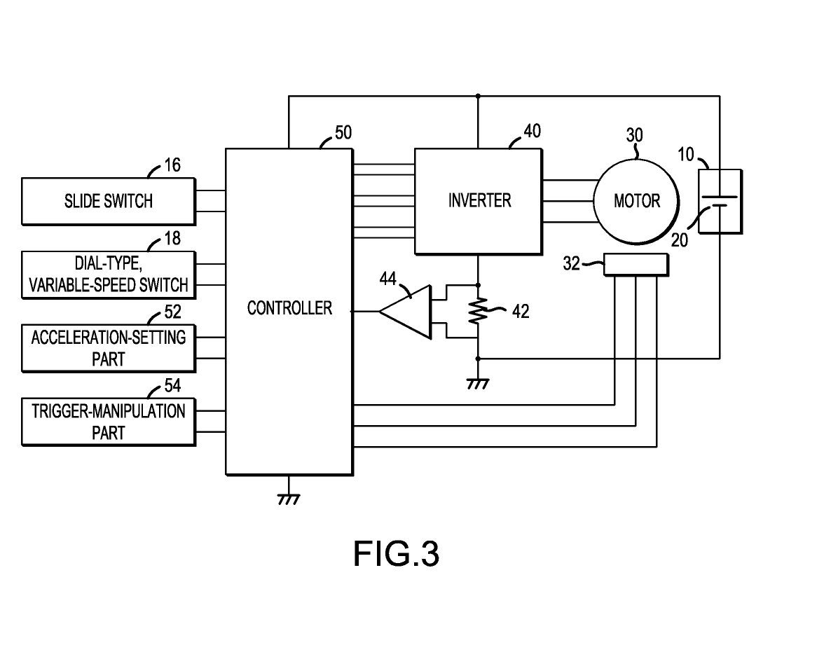

As shown in FIG. 1, grinders 2 of the embodiments described herein may principally comprise a motor housing 4, a gear housing 6, and a rear housing 8. The motor housing 4 has a circular-cylinder shape, which has an outer diameter (shell) that can be grasped by a user, and houses a motor 30 (refer to FIG. 3) in the interior thereof. The motor 30 is disposed inside the motor housing 4 such that a rotary shaft of the motor 30 is substantially parallel (or coincides) with the central longitudinal axis of the motor housing 4, and the rotary shaft of the motor 30 projects toward the gear housing 6.

The rear housing 8 is provided on one end of the central longitudinal axis of the motor housing 4 (more specifically, on the side of the motor housing 4 opposite the gear housing 6). In addition, a battery mounting part 8A is provided on a rear end of the rear housing 8 on the side opposite the motor housing 4. A rechargeable battery pack 10, i.e. a direct-current power supply, can be detachably mounted on the battery mounting part 8A.

A slide switch (ON/OFF switch) 16 enables the user to manually input (ON/OFF) commands for driving/stopping the motor 30 and is provided on the motor housing 4. The slide switch 16 serves as a representative, non-limiting example of an operation part according to the present disclosure.

A dial-type, variable-speed switch 18 enables the user to manually set the target (maximum) rotational speed when the motor 30 is being driven during a processing operation and is provided on the rear housing 8. The dial-type, variable-speed switch 18 serves as a representative, non-limiting example of a rotational speed setting part according to the present disclosure. Such a switch 18 is also known as a potentiometer, variable resistor, rheostat, etc.

It is noted that, although a rotatable dial-type, variable-speed switch 18 is utilized in the present embodiment for the user to (manually) variably set the desired target rotational speed of the motor 30, for example, one or more pushbutton (e.g. up/down) switches may be provided instead of the dial-type, variable-speed switch 18. In such an alternative embodiment, the rotational speed of the motor 30 may be changed in steps in proportion to the number of times the pushbutton switch(es) is/are pressed. For example, a first pushbutton switch may be provided to input rotational speed increases and second pushbutton switch may be provided to input rotational speed decreases. The two pushbutton switches optionally may be incorporated into a single up/down switch unit. Thus, such pushbutton switch(es) serve(s) as another representative, non-limiting example of a rotational speed setting part according to the present disclosure.

Of course, other types of rotational speed setting parts/devices may be utilized with the present teachings. For example, a linear slide switch (linear potentiometer, resistive switch, etc.) may be utilized such that provides rotational speed signals to the control unit based upon changes in resistance set by manually moving a lever or tab. A digital potentiometer also may be used. Furthermore, the electric rotary tool or machine may be equipped with a wireless communication device (e.g., WiFi, Bluetooth®, near field communication, etc.) that enables the rotational speed and/or other operating parameters to be set, e.g., using an app on a smartphone, tablet, PC, etc.

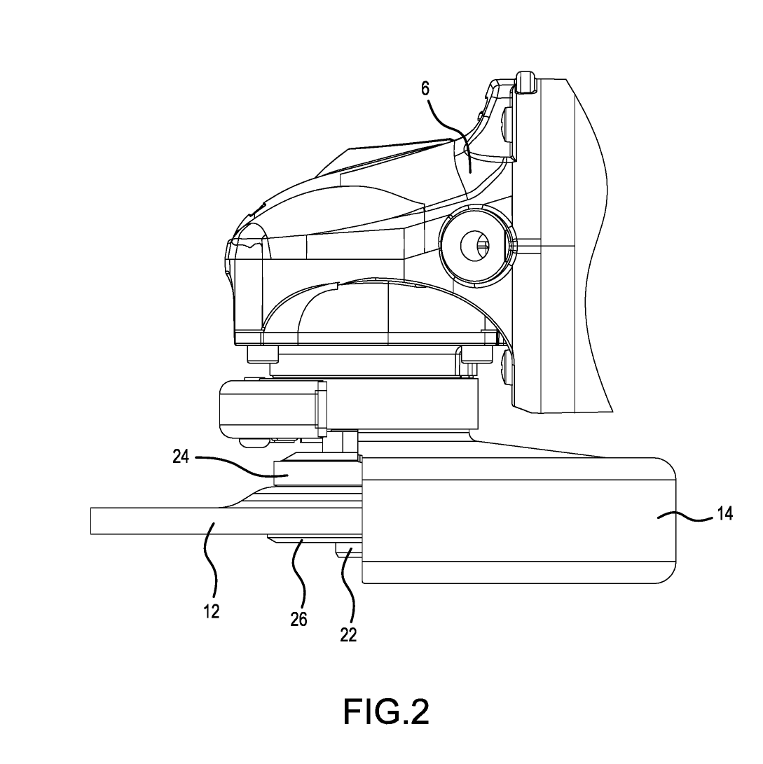

Referring now to FIG. 2, a spindle 22, which serves as a representative, non-limiting example of an output shaft (rotary output shaft) according to the present teachings, is rotatably housed in the gear housing 6, and one end of the spindle 22 projects from the gear housing 6. The spindle 22 is disposed such that its central axis, which is the center of rotation, is substantially orthogonal to the rotary shaft of the motor 30 that projects from the motor housing 4 towards the gear housing 6. Furthermore, the spindle 22 is coupled to the rotary shaft of the motor 30 via a gear mechanism housed inside the gear housing 6.

It is noted that the gear mechanism is provided for converting the rotation of the motor 30 into the rotation of the spindle 22 and may be constituted, e.g., by a bevel gear, etc.; however, any known rotation-transmission configuration of well-known grinders or other electric rotary tools and machines, including e.g., reduction gears, may be used with the present teachings, and therefore detailed explanation thereof is omitted herein.

An inner flange 24 is provided for positioning and fixing a tool accessory 12 having a discoidal (disk) shape. The inner flange 24 is provided on the spindle 22 that projects from the gear housing 6. A lock nut 26 securely holds the tool accessory 12 between the inner flange 24 and the lock nut 26 by being screwed onto a thread defined on the spindle 22 between the inner flange 24 and the tip of the spindle 22. The lock nut 26 serves as a representative, non-limiting example of a fastener of the tool accessory according to the present teachings. The lock nut 26 and threaded spindle 22 may be replaced, e.g., with a screw that screws into a threaded hole defined in the spindle (output shaft). Of course, in some alternate embodiments of the present disclosure, the tool accessory itself may include a fastener (e.g., an integral fastener) that connects the tool accessory to the output shaft, e.g., via a threaded connection or threaded fastener.

Thus, by providing (disposing) the tool accessory 12 between the inner flange 24 and the lock nut 26 and then tightening the lock nut 26 toward the inner flange 24, the tool accessory 12 can be securely fixed to the spindle 22. It is noted that, in the grinder 2 of the present embodiment, a grinding stone, a cutting stone, a wire brush, etc. serve as representative, non-limiting examples of a tool accessory according to the present disclosure. In other embodiments of the present teachings, rotary cutting blades, wheels, abrasive disks, etc. may serve as the rotatable tool accessory depending upon the particular application of the present teachings.

In addition, a wheel cover 14 may be provided to protect the user from the scattering of debris emanating from the workpiece, the tool accessory 12, or the like during the processing operation, such as grinding, polishing, or cutting. The wheel cover 14 is securely fixed onto the gear housing 6 around the projecting portion of the spindle 22.

It is noted that the wheel cover 14 has a substantially semicircular shape such that it covers, from the gear housing 6 side, a portion (in the present embodiment, substantially half) of the tool accessory 12, which is fixed to the spindle 22.

Referring now to FIG. 3, an inverter 40 and a controller 50 receive electric power from a battery 20 inside the battery pack 10 and serve as a representative, non-limiting example of a control unit for driving/stopping the motor 30 according to the present disclosure. The inverter 40 and the controller 50 are housed inside the rear housing 8.

The motor 30 is preferably a three-phase brushless motor, and the inverter 40 may comprise a known bridge circuit, which is capable of switching the current path to each phase winding of the motor 30. The inverter 40 preferably comprises three switching devices, which are provided between a positive electrode of the battery 20 and terminals of phases U, V, W of the motor 30, and three switching devices, which are provided between a negative electrode of the battery 20 and terminals of the phases U, V, W of the motor 30.

In such an embodiment, when the motor 30 is to be stopped, a desired braking force can be generated, e.g., by: all-phase short-circuit braking, in which a braking current is applied to all windings of the motor 30 via the inverter 40; or two-phase, short-circuit braking, in which a braking current is applied to some (e.g., two) of the windings of the motor 30.

It is noted that various types of braking control, in which the braking force is adjusted (varied) by the switching of the short-circuit braking in this manner, are described in detail in, for example, Japanese Laid-open Patent Publication 2013-243824 and its counterpart US 2013/307446, the contents of which are incorporated herein by reference. Therefore, detailed explanation of braking control techniques is omitted herein.

In addition, a resistor 42 for electric-current detection is provided in the current path extending from the inverter 40 to the negative electrode of the battery 20, and the voltages on both sides thereof are input to the controller 50 via an electric-current detection part 44.

Furthermore, a rotation-detection part 32 detects the rotational position of the motor 30 (in other words, rotational-angle: electrical-angle) and is provided on the motor 30. The rotation-detection part 32 preferably comprises three Hall-effect sensors, which are disposed around the rotor of the motor 30 at 120° intervals of the electrical angle, and the output from each Hall-effect sensor is wave-shaped and then input to the controller 50.

Consequently, in the controller 50, the rotational position of the motor 30 is detected from the edge of the input signal from each Hall-effect sensor at 60° intervals of the electrical angle, and the rotational speed of the motor 30 can be calculated from the edge intervals. It is noted that, in the present specification, the rotational speed of the motor 30 is the number of rotations of the motor rotor per unit of time (e.g., rotations per minute or “rpm”).

The controller 50 preferably comprises a microcomputer (e.g., a microcontroller) that includes a CPU and memory, such as, e.g., ROM and RAM, and the driving/stopping of the motor 30 are switched in accordance with the ON-OFF state of the slide switch 16, which is operated (manually switched) by the user. As will be further explained below, one or more programs (set(s) of instructions) are stored in the memory that, when executed by the CPU, cause the controller 50 and inverter 40 to perform the various functions that are described above and below.

In addition, when the motor 30 is being driven, the controller 50 reads, from the dial-type, variable-speed switch 18, the target (maximum) rotational speed set by the user and controls the energizing current supplied to the motor 30 using the inverter 40 such that the actual rotational speed of the motor 30 becomes (increases to) the set target rotational speed. The target rotational speed set by the user is thus the desired maximum rotational speed of the spindle 22 (and thus the tool accessory 12) during the workpiece processing operation.

In addition, when the motor 30 is to be stopped, the controller 50 performs braking control by applying one or more selected (described below) braking currents to the motor 30 using the inverter 40 by the switching of the short-circuit braking described above, thereby generating the desired (appropriate) braking force.

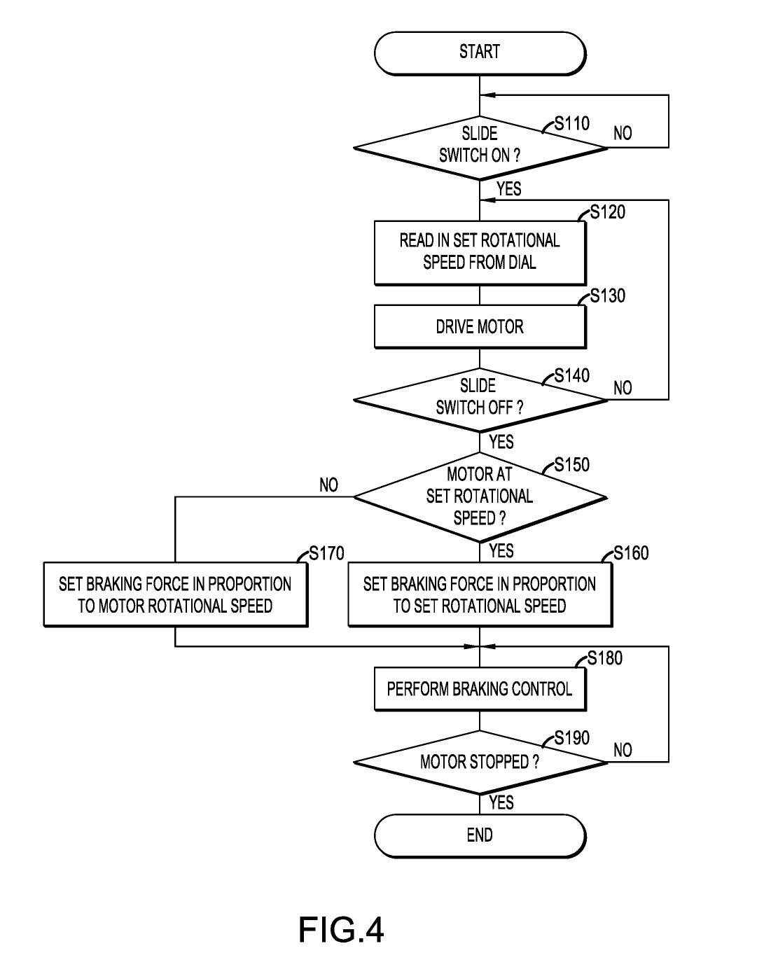

A representative, non-limiting example of a control process (algorithm) executed by the controller 50 in this manner is explained below, with reference to the flow chart shown in FIG. 4. As shown in FIG. 4, in S110 of the control process executed by the controller 50, the control process (control unit) first stands by for the switch SW 16 to be switched to the ON state by determining whether the slide switch 16 (hereinbelow referred to as the slide SW) is in the ON state. For example, the controller 50 may detect when a current is flowing through the slide switch 16 to determine that the slide switch SW 16 is in the ON state.

Then, when it has been determined that the switch SW 16 has been switched to the ON state, the control process transitions to S120, wherein the target rotational speed of the motor 30 that was (manually) set by the user is read from the dial-type, variable-speed switch 18, and then the control process transitions to S130.

In S130, a motor-drive process is executed in which the motor 30 is driven such that the rotational speed of the motor 30 calculated based on the detection signal from the rotation-detection part 32 becomes the set rotational speed. Then, continuing to S140, the control process determines whether the switch SW 16 has been switched to the OFF state. For example, the controller 50 may check whether no current is flowing through the switch 16 to determine that it has been turned OFF. The control process transitions once again to S120 if the switch SW 16 has not been switched to the OFF state or it transitions to S150 when the switch SW 16 has been switched to the OFF state.

In S150, it is determined by the motor-drive process of S130 whether the rotational speed of the motor 30 has reached (increased to) the target rotational speed that was set using the dial-type, variable-speed switch 18. Then, when it is determined in S150 that the rotational speed of the motor 30 has reached the set rotational speed, the control process transitions to S160 and sets (selects) the braking force to be generated by the braking control based on the set rotational speed. The control process then transitions to S180 to perform braking control.

On the other hand, if it is determined in S150 that the rotational speed of the motor 30 has not yet reached the set rotational speed, then the control process transitions to S170 and sets (selects) the braking force to be generated by the braking control based on the current (actual) rotational speed of the motor 30. The control process then transitions to S180 to perform braking control.

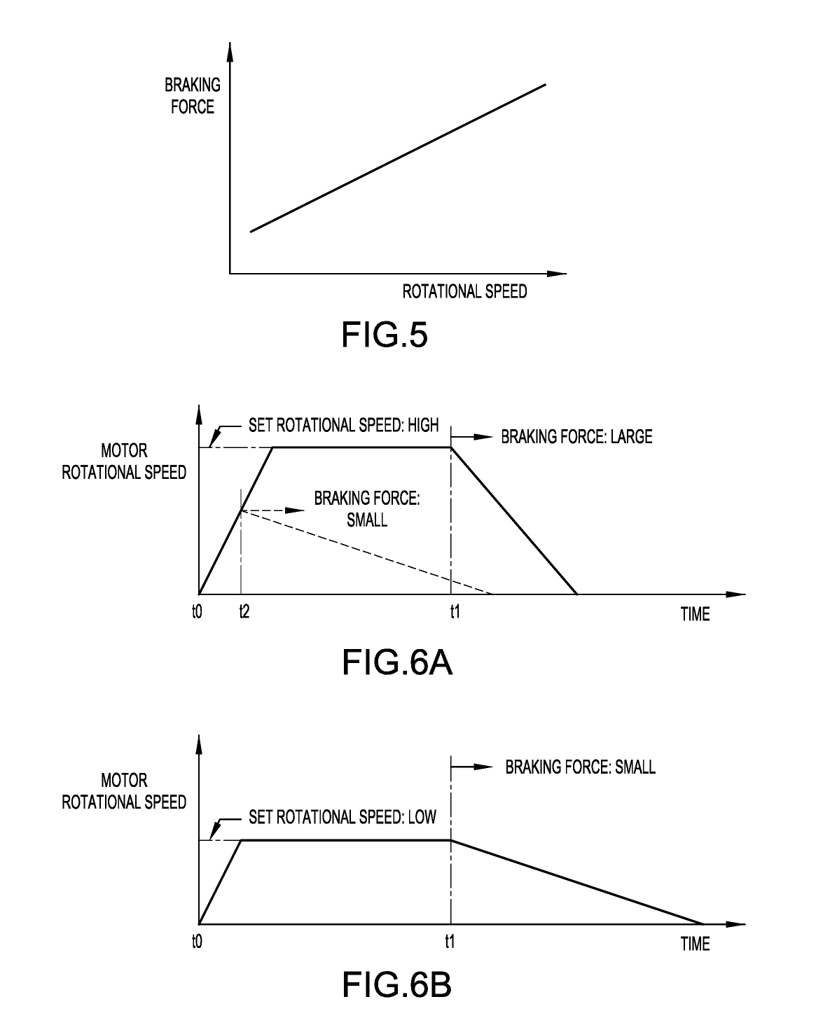

It is noted that, a pre-set (stored) map (graph, lookup table, etc.) may be used to set the braking force in S160 or S170, such that the higher the rotational speed of the motor 30 when the slide switch 16 is turned OFF, the greater the braking force that will be applied during braking control, as shown in FIG. 5.

In S180, a braking control that is suited to generating the braking force set in S160 or S170 is selected from among a plurality of types of braking control, each having a different braking current; by performing the selected braking control, a braking force is caused to be generated in the motor 30.

It is noted that, in S180, the short-circuit braking suited to generating the set braking force may be selected from among a plurality of types of predetermined short-circuit braking. The plurality of types of specified short-circuit braking includes all-phase short-circuit braking and two-phase short-circuit braking. The two-phase short-circuit braking is further categorized into different types depending on the number of switching devices in use, or the like.

While the braking control is being performed in S180, the control process determines, in S190, whether the motor 30 is stopped (in other words, whether the rotational speed has become zero). For example, if the controller 50 determines that the signal from the rotation-detection part 32 is not changing or is changing by less than a threshold amount, the controller 50 may determine that the motor 30 has stopped. Then, if it is determined in S190 that the motor 30 is not stopped, the control process transitions once again to S180 and continues the braking control; on the other hand, when it is determined in S190 that the motor 30 is stopped, the control process ends for the time being.

As explained above, the grinder 2 of the present embodiment is configured such that the rotational speed when the motor 30 is being driven during a processing operation can be variably set using the dial-type, variable-speed switch 18. In such an embodiment, when the slide switch 16 is switched to the ON state by the user, the controller 50 determines that a command to drive the motor 30 has been input, it starts the motor 30, and it performs drive control of the motor 30 such that the rotational speed of the motor 30 becomes (increases to) the set rotational speed.

Then, when the slide switch 16 is switched to the OFF state by the user while the motor 30 is being driven, the controller 50 determines that a command to stop the motor 30 has been input and therefore it stops the drive of (i.e. stops the supply of energizing current to) the motor 30 and starts the braking control.

Furthermore, in the braking control according to the present embodiment, the braking force generated in the motor 30 is controlled in proportion to the set target rotational speed, which is the target rotational speed when the motor 30 is started up, such that the higher the set rotational speed, the greater the braking force that is applied during the braking control.

Accordingly, as shown in FIG. 6A, when the set target rotational speed at start up (time t0) of the motor 30 is high and the motor 30 is driven up to that set target rotational speed, the motor 30 is decelerated by applying a relatively large braking force when the slide switch 16 is turned off (time t1).

This relatively large braking force is permissible because, when the set target rotational speed is relatively high (large), the tool accessory 12 is securely tightened to the spindle 22 by the lock nut 26 owing to the rotational speed increase (acceleration) after startup of the motor 30. That is, in this case, even though a large braking force is generated by the braking control when the motor 30 is being stopped, the motor 30 can be stopped in a short time without loosening of the lock nut 26 that secures the tool accessory 12 to the spindle 22.

In contrast, as shown in FIG. 6B, when the rotational speed that is set at startup (time t0) of the motor 30 is small (relatively low) and the motor 30 is only driven up to that lower set target rotational speed, the motor 30 is decelerated by applying a relatively small (low) braking force when the slide switch 16 is turned off (time t1).

This lower braking force is required because, when the set target rotational speed is relatively low, the rotational speed of the motor 30 after startup reaches the set target rotational speed in a short time; therefore, compared with the case in which the set target rotational speed is high, less tightening of lock nut 26 and thus the tool accessory 12 occurs during the motor startup phase. That is, in this case, the braking force generated by the braking control is set to a relatively small value and thereby the motor 30 is decelerated more slowly to minimize or even eliminate the likelihood that the lock nut 26 will loosen due to the braking control performed when the motor 30 is being stopped.

Therefore, according to the grinder 2 of the present embodiment, by controlling (appropriately increasing/decreasing) the braking force generated by the braking control while the motor 30 is being stopped, the rotation of the motor 30 can be stopped in a shorter time while also minimizing or avoiding the risk that the lock nut 26 will loosen during the braking control.

In addition, in the present embodiment, if the slide switch 16 is turned off (time t2) within the interval from after motor startup until the rotational speed of the motor 30 reaches the set target rotational speed (i.e. the slide switch 16 is turned off at a time when the rotational speed is less than the set target rotational speed) as shown by the dotted line in FIG. 6A, then the braking force generated by the braking control is set based on the actual (current) rotational speed of the motor 30 at that time.

Accordingly, in this case in which braking control is performed from time t2 onward, the motor 30 is decelerated with a braking force that is smaller (lower) than a (higher) braking force corresponding to the set target rotational speed, and therefore it is possible to minimize or avoid the risk that the braking force is excessive compared to the lock nut tightening during motor startup. Therefore, according to the grinder 2 of the present embodiment, the risk that the lock nut 26 loosens as a result of the braking control can be further minimized or even avoided.

### Second Embodiment

In the first embodiment, it was described that, if the slide switch 16 is turned OFF and thus a command to stop the motor 30 is input, then the braking control is performed and, under that braking control, the braking force generated in the motor 30 owing to the braking current flowing to the motor 30 is controlled (variably adjusted as needed in view of the rotational speed of the motor 30).

In contrast, in the second embodiment, when a command to stop the motor 30 is input, the flow of current to the motor 30 is first cut off without applying a braking force for a prescribed (predetermined) standby time, and then, after the standby time has elapsed, braking control is performed by applying the braking current to the motor 30 in a manner similar to the first embodiment.

Preferably, the braking force after the input of the stop command can be reduced or minimized by adjusting (increasing/decreasing) the standby time interval from the cut-off of the flow of current to the motor 30 until the braking control is started (i.e. a braking current is supplied to the motor 30).

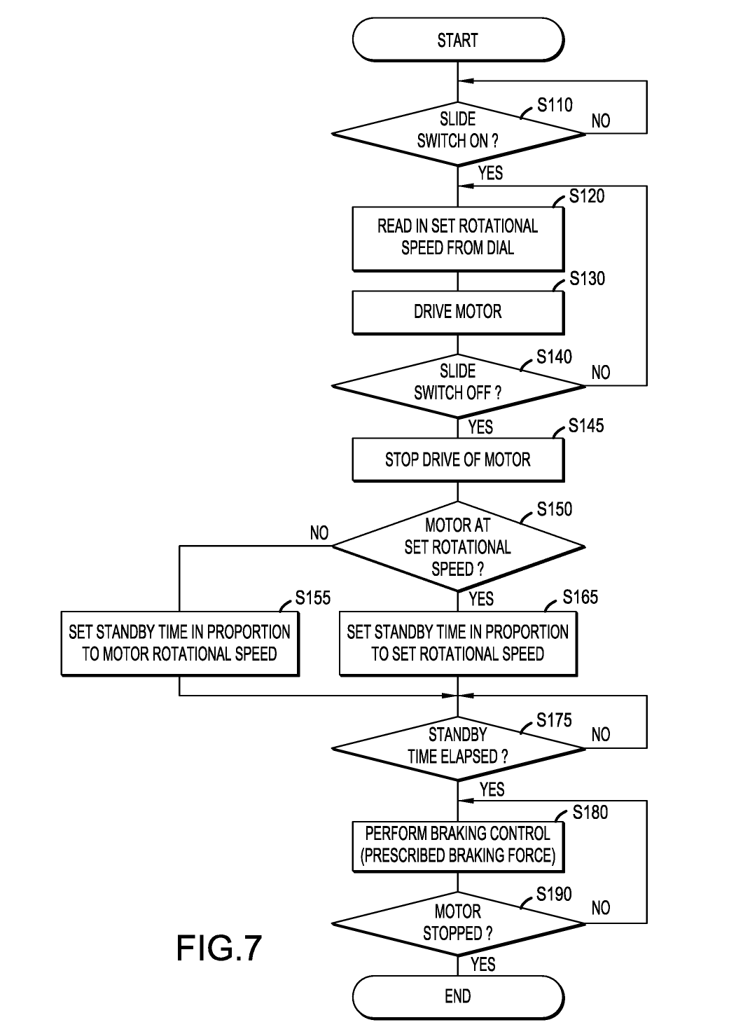

A representative, non-limiting control process (algorithm) executed by the controller 50 to perform the braking control in this manner is explained below, with reference to the flow chart shown in FIG. 7.

Because the control process shown in FIG. 7 contains some of the same steps as the control process of the first embodiment shown in FIG. 4, only those points (steps) that differ from the control process of the first embodiment are explained hereinbelow. Description concerning the remaining steps is incorporated herein by reference from the above description of the control process of FIG. 4.

As shown in FIG. 7, when it is determined in S140 that the switch SW 16 has been switched to the OFF state and thus a command to stop the motor 30 has been input, the control process transitions to S145 and the drive of the motor 30 is stopped by turning off all the switching devices inside the inverter 40 (i.e. energizing current is no longer supplied to the motor 30). It is noted that, when the drive of the motor 30 is stopped in this manner, the motor 30 enters a free-running state and thus decelerates relatively slowly, because no braking force (braking current) is being applied to (generated in) the motor 30. That is, only internal frictional forces of bearings, gears, etc. cause the motor 30 and spindle 22 to slow down.

When the drive of the motor 30 stops in S145, the control process transitions to S150 and then it is determined whether the rotational speed of the motor 30 has reached the set target rotational speed. If it is determined in S150 that the rotational speed of the motor 30 had reached the set target rotational speed, the control process transitions to S165 and the standby time to wait until the braking control will start is set (selected) based on the set target rotational speed.

On the other hand, if it is determined in S150 that the actual (current) rotational speed of the motor 30 did not reach the set target rotational speed, then the control process transitions to S155 and the standby time to wait until the braking control will start is set (selected) based on the actual (current) rotational speed of the motor 30, rather than based the set target rotational speed which is higher than the actual (current) rotational speed.

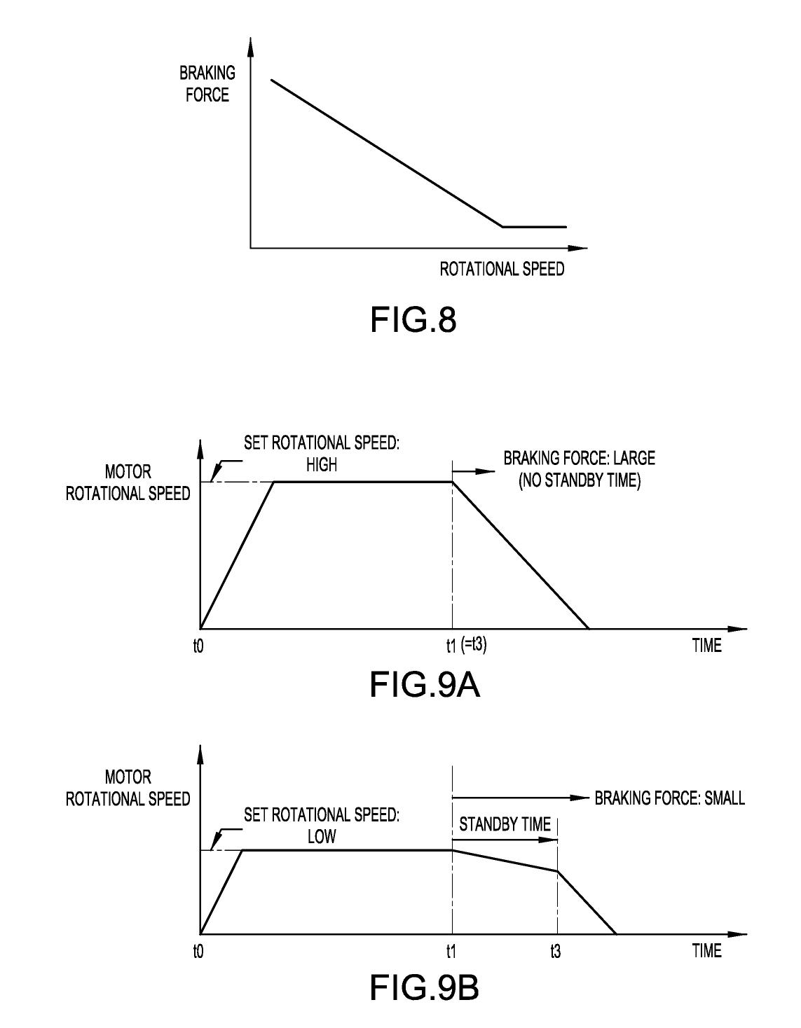

It is noted that, a preset (stored) map (graph, lookup table, etc.) may be used to set the (prescribed or predetermined) standby time in S165 or S155, such that the higher the rotational speed of the motor 30 at the time the switch 16 is turned OFF, the shorter the standby time, as shown in FIG. 8.

After the standby time has been set in S165 or S155, the control process transitions to S175 and then waits for the set standby time to elapse. Then, in S175, when it is determined that the standby time has elapsed, the control process transitions to S180 and causes a prescribed braking force to be generated in the motor 30 by performing the braking control using the above-described predetermined (stored) short-circuit braking.

It is noted that, when (while) the braking control is being performed in S180, the control process determines in S190 whether the motor 30 has stopped; if the motor 30 has not stopped, then S180 is further performed; on the other hand, if the motor 30 has stopped, then the control process ends for the time being.

Thus, in the grinder 2 of the present (second) embodiment, when a command to stop the motor 30 is input, the drive of (the energizing current supplied to) the motor 30 is stopped without generating a braking force in the motor 30 for a prescribed standby time, and then, after the prescribed standby time has elapsed, the braking control is started. Furthermore, the standby time may be set in proportion to the set rotational speed that is the target rotational speed when the motor 30 is started, such that the higher the set target rotational speed, the shorter the standby time.

Accordingly, as shown in FIG. 9A, when the set rotational speed at start up (time t0) of the motor 30 is high and the motor 30 is driven up to that set rotational speed, and then when the slide switch 16 is turned off (time t1), the braking control is started promptly with little or no standby time.

This short standby time is permissible because, when the target rotational speed that was set during motor startup is high, the tool accessory 12 is securely tightened to the spindle 22 by the lock nut 26 owing to the rotational speed increase (acceleration) after startup of the motor 30. That is, in this case, even if the braking control is started (i.e. the braking force is applied/generated) immediately when the drive of the motor 30 is stopped, the motor 30 can be stopped in a shorter time without the risk of the lock nut 26 (and thus the tool accessory 12) loosening.

In contrast, as shown in FIG. 9B, when the target rotational speed that was set at startup (time t0) of the motor 30 is low and the motor 30 is driven up to that lower set target rotational speed, when the slide switch 16 is turned off (time t1), the drive of the motor 30 is stopped and a longer standby time is set corresponding to the lower target rotational speed. Because the braking control is not performed in the standby state, the motor 30 rotates by inertia until the standby time elapses, and the rotational speed of the motor 30 decreases slowly, thereby avoiding the risk that the lock nut 26 will loosen.

Then, when the standby time after the drive of the motor 30 has stopped (time t1) has elapsed (time t3), the braking control is started and the braking force is generated in the motor 30. Then, the motor 30 decelerates more quickly because of the generation/application of that braking force and stops.

Therefore, according to the grinder 2 of the present (second) embodiment, by reducing the standby time to wait until the braking control will be started after the drive of the motor 30 has stopped (in case the rotational speed of the motor 30 is high), the braking time required to stop the motor 30 from the drive state can be reduced.

Thus, in such a braking control as well, when the motor 30 is rotating at high speed, a larger braking force may be applied to stop the motor 30, and when the motor 30 is rotating at low speed, a smaller braking force will be applied to stop the motor 30.

Therefore, in the grinder 2 of the present (second) embodiment as well, the rotation of the motor 30 can be stopped in a shorter time while minimizing or avoiding the risk that the lock nut 26 loosens during deceleration of the motor 30.

### Modified Example 1

In the above embodiments, it was described that, after a command to stop the motor 30 has been input to the controller 50, the braking force generated when the motor 30 is being stopped, including (optionally) the standby time, is set based on the set rotational speed when the motor 30 is started up.

In the above embodiments, the acceleration of the motor 30 during startup (i.e. from standstill until the target rotational speed is reached) is either constant (or substantially constant) or follows a predetermined acceleration profile (pattern), such that the tightening force (torque) applied to the lock nut 26 during motor start up directly corresponds (is directly proportional) to the target rotational speed or to a lower rotational speed, in case the target rotational speed was not reached when the slide switch 16 was turned off. That is, because the amount of tightening force (torque) applied to the lock nut 26 corresponds to the amount of acceleration (more particularly, to the acceleration of the output shaft integrated over time, which is also known as “angular impulse”), the peak rotational speed directly corresponds to the angular impulse. Thus, in such embodiments, the braking force (braking current) and optionally the standby time can be selected from predetermined (prescribed) braking forces (braking currents) and standby times that are stored in the electric rotary tool and correspond to the peak (actual) rotational speed.

However, if an acceleration-setting part 52 (as shown by the dotted line in FIG. 3) is provided for manually setting (selecting) the amount of acceleration when the motor 30 is started up, then the braking force may be (variably) set, at least in part, based on the acceleration set by the user using the acceleration-setting part 52.

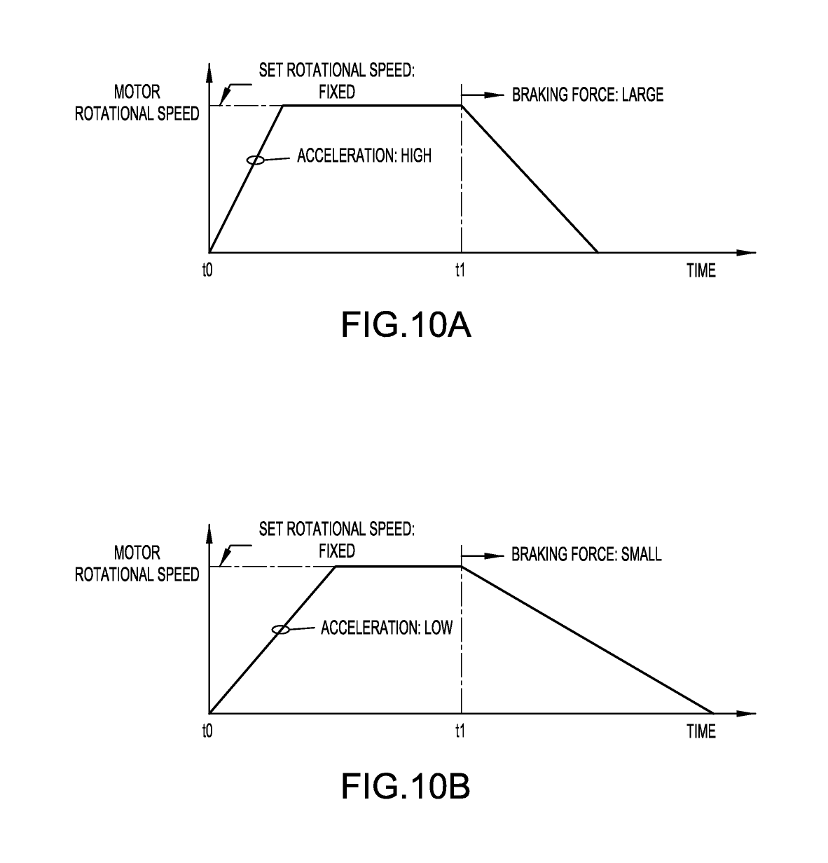

That is, as shown in FIG. 10A, if the acceleration is high (large) while the rotational speed is being increased to the set target rotational speed after startup (time t0) of the motor 30, then the braking force generated in the motor 30 due to the braking control after the drive of the motor 30 has stopped (time t1) is also preferably relatively high (large).

On the other hand, as shown in FIG. 10B, if the acceleration is low (small) while the rotational speed is being increased to the set target rotational speed after startup (time t0) of the motor 30, the braking force generated in the motor 30 due to the braking control after the drive of the motor 30 has stopped (time t1) is also preferably relatively low (small).

Thus, by reducing braking force generated by the braking control while the motor 30 is being stopped when a lower acceleration during motor startup is set, the rotation of the motor 30 can still be stopped in a shorter time without increasing the risk of the lock nut 26 loosening during the braking control.

It is noted that, although the set rotational speed when the motor 30 is started up is a fixed target rotational speed in FIG. 10, an embodiment may be configured such that both the target (peak or maximum) rotational speed and the acceleration when the motor 30 is started up can be (manually) set by the user. Furthermore, in such an embodiment, the braking force generated by the braking control (or the standby time of the second embodiment) while the motor 30 is being stopped may be set using both the set target rotational speed and the set acceleration.

Furthermore, in such embodiments, the user may manually (variably) set both the acceleration and the target (peak or maximum) rotational speed for a particular processing operation, but it is possible that the slide switch 16 is turned OFF before the motor 30 reaches the target rotational speed. In this case as well, the braking force (and optionally the standby time) may be optionally set based upon the set acceleration and the peak rotational speed reached by the motor 30 prior to shutting off the current to the motor 30. For example, in one embodiment, predetermined maps, graphs, lookup tables, etc. may be stored in the control unit and the braking force (and optionally the standby time) may be selected by inputting the set (target) acceleration and the peak rotational speed prior to shutting off the motor 30. In another embodiment, the control unit may store a program that calculates the angular impulse applied to the output shaft, e.g., by integrating the set acceleration over the time that motor 30 was accelerated. Then, the braking force may be selected based upon the calculated angular impulse, i.e. the braking force may be selected in proportion to the calculated angular impulse.

### Modified Example 2

In the above embodiments, although it was described that the target rotational speed when the motor 30 is started up is set via (using) the dial-type, variable-speed switch 18, the above embodiments may be configured (modified) such that the target rotational speed is not limited to being set only when the motor 30 is being started up. Instead the target rotational speed may be modified (increased/decreased) by the user at any time during a processing operation.

For example, the above embodiments can be configured (modified) such that the user can modify (increase/decrease) the set target rotational speed at any time using the dial-type, variable-speed switch 18 or by using a trigger-manipulation part 54, which is shown in FIG. 3. It is noted that the trigger-manipulation part 54 is well known technology, comprising a trigger (trigger switch) for the user to operate (manipulate) by pulling and is configured such that a rotational speed command can be transmitted to the motor 30 in proportion to the amount by which the trigger is pulled (squeezed).

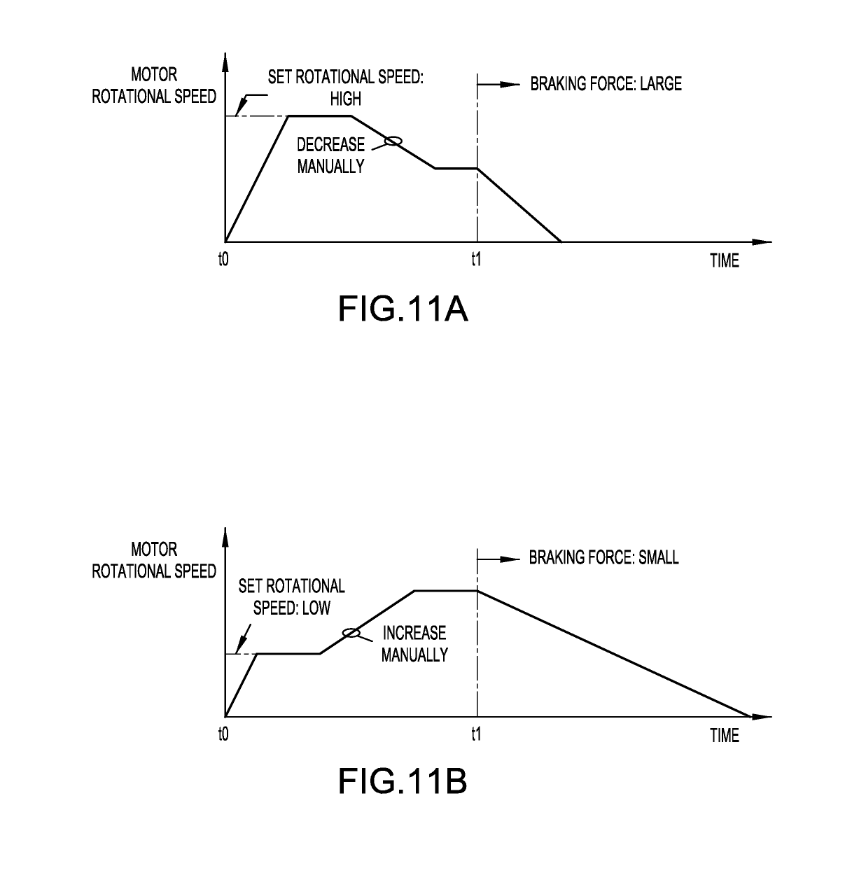

If the grinder 2 is configured in this manner, then even if the set rotational speed when the motor 30 is started up is large as shown in FIG. 11A and/or even if the set rotational speed when the motor 30 is started up is small as shown in FIG. 11B, the set target rotational speed during drive of the motor 30 may be modified manually.

Furthermore, even if the set target rotational speed is thus modified from its initial value, the controller 50 is configured to set, based on the set rotational speed (the initial value) when the motor 30 is started up, the braking force generated by the braking control (or the standby time) when the motor 30 is being stopped, in the same manner as the above embodiments.

In so doing, the braking force generated while the motor 30 is being stopped can be made to correspond to the tightening force by which the lock nut 26 (and thus the tool accessory 12) is tightened due to the rotational speed increase (acceleration, angular impulse, etc.) of the motor 30 when the motor 30 is started up, and thereby it is possible to reduce or avoid the risk that the lock nut 26 (and thus the tool accessory 12) loosens when the braking control is performed.

Although embodiments of the present disclosure were explained above, the present disclosure is not limited to these embodiments, and it is understood that variations and modifications may be effected without departing from the spirit and scope of the invention.

For example, in the above embodiments, although it was explained that the set rotational speed when the motor 30 is started up is used to set the braking force generated by the braking control (or the standby time) when the motor 30 is being stopped, the manipulation amount (manual setting) of the rotational speed setting part may be used instead. Specifically, the braking force generated by the braking control (or standby time) may be set using a variable speed position of the dial-type, variable-speed switch 18, the pull amount of the trigger-manipulation part 54, or the like.

In addition, in the above embodiments, grinders 2 were described in which the motor 30 is configured as a three-phase brushless motor and the grinders 2 operate by receiving electrical power from the battery 20. However, the technology of the present disclosure can be readily adapted to other embodiments in the same manner as the above embodiments even if, for example, it is an electric rotary tool or machine (e.g., an electric work machine) in which the motor is a DC motor having brushes and it operates by receiving electric power (current) from an AC power supply.

In addition, in the above embodiments, it was described that, when the motor 30 is being stopped, the braking force is generated by applying the braking current to the motor 30. However, an electric rotary tool or machine (e.g., an electric work machine) may be configured such that, for example, a mechanical braking apparatus (a disk brake, brake pad or the like) is provided on the rotary shaft of the motor 30 or on the spindle 22, and the rotation thereof is directly (mechanically) braked (e.g., by friction) by the braking apparatus. That is, even in such embodiments, by adjusting the braking force using the braking apparatus according to present teachings, effects the same as those in the above embodiments can be obtained.

Moreover, although grinders 2 were described in the above embodiments as a representative example of the electric rotary tool or machine (e.g., electric work machine), the present teachings are applicable to any device configured such that the tool accessory (or a threaded fastener thereof) is tightened by the rotational speed increase, acceleration, angular impulse, etc. of the output shaft when the motor is started up, and a braking force is generated by braking control to stop the motor more quickly. Specifically, for example, circular saws, mowers, etc. can be given as additional representative examples of rotary tools and machines, to which the techniques of the present disclosure can be applied.

In addition, a plurality of functions having one structural element in the above embodiments may be implemented by a plurality of structural elements, one function having one structural element may be implemented by a plurality of structural elements, and so on. In addition, a plurality of functions having a plurality of structural elements may be implemented by one structural element, one function implemented by a plurality of structural elements may be implemented by one structural element, and the like. In addition, some of the structural elements in the above embodiments may be omitted. In addition, at least some of the structural elements in the above embodiments may be added to or replaced by structural elements in other embodiments mentioned above. It is noted that any aspect that is included in the technical concepts specified based on the text of the claims is an embodiment of the present invention.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rotary tools and machines.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the control unit (controller 50 and inverter 40), is also understood as a corresponding method step or as a feature of a method step. In an analogous manner, aspects which have been described in the context of or as a method step also represent a description of a corresponding block or detail or feature of a corresponding device, such as the control unit.

Depending on certain implementation requirements, exemplary embodiments of the control unit of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the control unit have been identified as “parts” or “steps”, it is understood that such parts or steps need not be physically separate or distinct electrical components, but rather may be different blocks of program code that are executed by the same hardware component, e.g., one or more microprocessors.

Further embodiments of the present disclosure include, but are not limited to, the following modifications.

For example, in the second embodiment described above, the controller 50 determines the rotational speed of the output shaft of the motor M when the switch 16 is turned OFF and then sets a standby time to wait until the braking current is applied. However, instead of setting a standby time, it is also possible to monitor the rotational speed of the output shaft and wait until the rotational speed has reduced below a prescribed threshold, before applying the braking force.

For example, the controller 50 may be configured to monitor the rotational speed of the output shaft, based upon signals from rotational speed detection part 32, in the free-run state (i.e. when the inverter 40 is no longer driving the motor 30, such that the output shaft is rotating from only inertia). Then, when the controller 50 determines that the rotational speed has fallen below a pre-set threshold (predetermined rotational speed), the braking current is then applied to bring the output shaft to a stop more quickly, similar to the above-described second embodiment.

Furthermore, in any of the embodiments described above or below, the braking force (or braking current) applied to the motor M may be either a fixed (constant) value, or may be variable.

For example, paragraphs [0031]-[0033] and [0138] of US 2013/307446 disclose variable braking force embodiments and the teachings of these paragraphs are incorporated herein by reference.

Thus, in one embodiment of the present teachings involving a variable braking force, when the motor M is rotating too fast such that full (maximum) braking can not applied without possibly causing the lock nut 26 to loosen, a smaller braking force may initially be applied while the motor is rotating relatively fast. Thus, even though the full braking force is not applied, the motor M can still be actively decelerated, thereby reducing the time until the output shaft stops, but by an amount of deceleration (braking force) that does not cause the lock nut 26 to loosen.

Then, as the rotational speed of the motor M further decreases, the braking force may be increased, either continuously or in discrete steps.

In such variable braking embodiments, the overall braking time may be reduced without increasing the risk of loosening the lock nut 26, as compared to allowing the motor to rotate in the free-running state (e.g., during a standby time) until the maximum (full) braking force can be applied.

Furthermore, all of the above-described embodiments utilize short-circuit braking by applying a braking current to the motor M or utilize a mechanical brake (e.g., brake pads or disk brake). However, in addition to or instead of applying a braking current to the motor M and/or using a mechanical brake, rheostatic dynamic braking may be utilized to generate a braking force in the motor M, e.g., by using rheostatic braking embodiments disclosed in U.S. Pat. No. 9,776,338, the contents of which are incorporated herein by reference.

In such rheostatic dynamic braking embodiments, a resistor may be connected to the motor M in order to generate a braking force in the motor M when it is desired to brake the output shaft rotation. In such embodiments, the controller 50 may be configured, e.g., to:

determine the rotational speed at the time the switch 16 is turned off (e.g., using signals from the rotation speed detecting part 32),

either (a) set a standby time (e.g., according to the above-described second embodiment) until connecting the rheostatic brake (resistor(s)) to the motor M or (b) determine when the rotational speed of the output shaft has fallen below a prescribed threshold (e.g., according to the above-described modified embodiment), and

then connect the rheostatic brake (resistor(s)) to the motor M to decelerate the motor M more quickly after the standby time has elapsed or the rotational speed of the output shaft has reduced to a predetermined rotational speed.

In such rheostatic dynamic braking embodiments, a single resistor (or a single resistive value obtained from a fixed set of resistors) may be connected to the motor M such that the resistance applied to the motor M is constant. In the alternative, a set of resistors may be connected in parallel or in series, so that a variable braking resistance may be applied to the motor M, e.g., in accordance with the preceding modified embodiment involving variable braking.

Of course, instead of rheostatic dynamic braking, regenerative dynamic braking is also possible in electric rotary tools and machines powered by a rechargeable battery. In such embodiments, the current generated by regenerative dynamic braking may be supplied to the rechargeable battery to recharge it.

1. An electric work machine comprising:

an output shaft configured such that a tool accessory can be mounted thereon by screwing a screw;

a motor that rotates the output shaft;

an operation part for commanding driving/stopping of the motor; and

a control unit that controls the driving/stopping of the motor in accordance with commands from the operation part;

wherein the control unit is configured to generate a braking force in the motor or on the output shaft when the motor is to be stopped in proportion to a tightening force of the tool accessory generated owing to the rotational speed increase when the motor is started up, such that the greater the tightening force, the greater the braking force.

2. The electric work machine according to embodiment 1, wherein:

the operation part comprises a rotational speed setting part that sets the rotational speed when the motor is being driven; and

the control unit is configured to control the braking force when the motor is being stopped in proportion to a set rotational speed that was set by the rotational speed setting part when the motor is started up.

3. The electric work machine according to embodiment 1, wherein:

the operation part is configured to set the rotational speed when the motor is being driven in proportion to a manipulation amount of the operation part; and

the control unit is configured to control the braking force when the motor is being stopped in proportion to the manipulation amount of the operation part when the motor is started up.

4. The electric work machine according to embodiment 2 or 3, wherein the control unit is configured such that, when the motor is being stopped in the state in which, after startup of the motor, the rotational speed of the motor did not reach the rotational speed set by the operation part, the braking force is made smaller than the braking force that corresponds to the set rotational speed.

5. The electric work machine according to embodiment 2 or 3, wherein the control unit is configured to set the braking force in proportion to the rotational speed when the braking of the motor is started when the motor is being stopped in the state in which, after startup of the motor, the rotational speed of the motor did not reach the rotational speed set by the operation part.

6. The electric work machine according to any one of embodiments 1-5, wherein the control unit is configured to control the braking force by controlling a braking current that flows to the motor when the motor is being stopped.

7. The electric work machine according to any one of embodiments 1-5, wherein the control unit is configured to stop the motor when a command to stop the motor is input from the operation part by cutting off the flow of current to the motor and, after the elapse of a prescribed standby time, by applying a braking current to the motor, thereby controlling the braking force by adjusting the standby time.

### EXPLANATION OF THE REFERENCE NUMBERS

2 Grinder
4 Motor housing
6 Gear housing
8 Rear housing
10 Battery pack
12 Tool accessory
14 Wheel cover
16 Slide switch
18 Dial-type, variable-speed switch
20 Battery
22 Spindle
24 Inner flange
26 Lock nut
30 Motor
32 Rotational speed detection part
40 Inverter
42 Resistor
44 Electric-current detection part
50 Controller
52 Acceleration-setting part
54 Trigger-manipulation part

I claim:

1. An electric rotary tool comprising:
an output shaft configured such that a tool accessory is mountable thereon by a threaded connection;
a motor that directly or indirectly rotates the output shaft;
an operation part for generating drive/stop commands for the motor; and
a control unit that controls the driving/stopping of the motor in part based upon the drive/stop commands from the operation part;
wherein the control unit is configured to cause a braking force to be generated in the motor and/or to be applied to the output shaft when the motor is to be stopped, the control unit variably setting the braking force in proportion to an amount of torque applied to the threaded connection as a result of acceleration of the output shaft during startup of the motor, such that the greater the torque applied to the output shaft during the startup of the motor, the greater the braking force generated or applied during braking control executed by the control unit.

2. The electric rotary tool according to claim 1, further comprising:
a rotational speed setting part configured to variably set a target rotational speed when the motor is being driven to perform a processing operation;
wherein the control unit is configured to control the braking force while the motor is being stopped in proportion to the target rotational speed that was set by a user using the rotational speed setting part.

3. The electric rotary tool according to claim 2, wherein:
the rotational speed setting part is configured to variably set the target rotational speed when the motor is being driven in proportion to a manipulation amount of the rotational speed setting part.

4. The electric rotary tool according to claim 3, wherein the control unit is configured such that, when the motor is being stopped in the state in which, after the startup of the motor, the rotational speed of the motor did not reach the target rotational speed set using the rotational speed setting part, the braking force is set to be smaller than a braking force that corresponds to the target rotational speed.

5. The electric rotary tool according to claim 3, wherein the control unit is configured to set the braking force in proportion to an actual rotational speed when the motor is to be stopped in the state in which, after the startup of the motor, the rotational speed of the motor did not reach the target rotational speed set using the rotational speed setting part.

6. The electric rotary tool according to claim 5, wherein the control unit is configured to control the braking force by controlling a braking current that is supplied to the motor while the motor is being stopped during the braking control.

7. The electric rotary tool according to claim 5, wherein the control unit is configured to stop the motor when the stop command to the motor is input via the operation part:
by first cutting off the flow of current to the motor without applying a braking force to the motor or output shaft for a predetermined standby time, and
then, after the predetermined standby time has elapsed, by supplying a braking current to the motor.

8. The electric rotary tool according to claim 1, wherein the control unit is configured to select the braking force in proportion to an angular impulse applied to the output shaft during a time interval between standstill of the motor and the motor reaching its peak rotational speed during startup of the motor.

9. The electric rotary tool according to claim 1, wherein:
the acceleration of output shaft during start up of the motor is at least substantially constant or follows a predetermined acceleration profile, and
the control unit is configured to set the braking force in proportion to a peak rotational speed of the motor during a processing operation.

10. The electric rotary tool according to claim 1, wherein the electric rotary tool is a grinder, a circular saw or a lawn motor.

11. The electric rotary tool according to claim 1, wherein the control unit is configured to control the braking force by controlling a braking current supplied to the motor while the motor is being stopped during the braking control.

12. The electric rotary tool according to claim 1, wherein the control unit is configured to stop the motor when a stop command to the motor is input via the operation part:
by first cutting off the flow of current to the motor without applying a braking force to the motor or output shaft for a predetermined standby time, and
then, after the predetermined standby time has elapsed, by supplying a braking current to the motor.

13. An electric rotary tool comprising:
an output shaft configured such that a tool accessory is mountable thereon by a threaded connection;
a motor that directly or indirectly rotates the output shaft;
an operation part for generating drive/stop commands for the motor;
a control unit that controls the driving/stopping of the motor in part based upon the drive/stop commands from the operation part; and
a rotational speed setting part configured to variably set a target rotational speed when the motor is being driven to perform a processing operation;
wherein the control unit is configured to cause a braking force to be generated in the motor and/or to be applied to the output shaft when the motor is to be stopped, the control unit variably setting the braking force in proportion to the target rotational speed that was set by a user using the rotational speed setting part.

14. The electric rotary tool according to claim 13, wherein the rotational speed setting part is configured to variably set the target rotational speed when the motor is being driven in proportion to a manipulation amount of the rotational speed setting part.

15. The electric rotary tool according to claim 14, wherein the control unit is configured to set the braking force in proportion to an actual rotational speed when the motor is to be stopped in the state in which, after the startup of the motor, the rotational speed of the motor did not reach the target rotational speed set using the rotational speed setting part.

16. The electric rotary tool according to claim 15, wherein the control unit is configured to control the braking force by controlling a braking current that is supplied to the motor while the motor is being stopped during the braking control.

17. The electric rotary tool according to claim 15, wherein the control unit is configured to stop the motor when a stop command to the motor is input via the operation part:
by first cutting off the flow of current to the motor without applying a braking force to the motor or output shaft for a standby time, and
then, after the standby time has elapsed, by generating a braking force in the motor.
